(19) United States
(12) Patent Application Publication
(10) Pub. No.: US 2026/0152201 A1
(43) Pub. Date: Jun. 4, 2026

(54) VEHICLE

(71) Applicant: TOYOTA JIDOSHA KABUSHIKI KAISHA, Toyota-shi (JP)

(72) Inventor: Kazuyuki Inoue, Nagoya-shi (JP)

(73) Assignee: TOYOTA JIDOSHA KABUSHIKI KAISHA, Toyota-shi (JP)

(21) Appl. No.: 19/272,339

(22) Filed: Jul. 17, 2025

(30) Foreign Application Priority Data
Nov. 29, 2024 (JP) 2024-208758

(51) Int. Cl. B60W 50/12; B60W 10/18; B60W 60/00

(52) U.S. Cl. CPC B60W 50/12; B60W 10/18; B60W 60/0053; B60W 2540/12

(57) ABSTRACT

The vehicle includes a vehicle control interface box that relays control communication between the autonomous driving kit and the braking function unit. The vehicle control interface box is configured to output a brake pedal intervention signal of a value in accordance with a braking operation received by a brake pedal to the autonomous driving kit, and when a requested deceleration by a braking instruction becomes larger than a first threshold value, in a determination period until a first period elapses, prohibit outputting of the brake pedal intervention signal of a specific value indicating that the braking operation is performed to the autonomous driving kit.

### CROSS-REFERENCE TO RELATED APPLICATION

This application claims priority to Japanese Patent Application No. 2024-208758 filed on Nov. 29, 2024. The disclosure of the above-identified application, including the specification, drawings, and claims, is incorporated by reference herein in its entirety.

### BACKGROUND

### 1. Technical Field

The present disclosure relates to a vehicle, particularly, to a vehicle configured to enable autonomous driving through an autonomous driving kit that is attachable and detachable and that issues an instruction for autonomous driving.

### 2. Description of Related Art

There is a vehicle configured to enable autonomous driving through an autonomous driving kit (hereinafter referred to as an “autonomous driving kit (ADK)”) that is attachable and detachable (for example, see Japanese Unexamined Patent Application Publication No. 2023-105002 (JP 2023-105002 A)). In the vehicle, a vehicle control interface box (hereinafter referred to as a “vehicle control interface box (VCIB)”) transmits an intervention signal of a brake pedal performed by a driver of the vehicle to the ADK.

### SUMMARY

In JP 2023-105002 A, the presence or absence of depression of the brake pedal is determined from a brake pedal depression amount. However, the brake pedal may move due to a factor other than an operation of the driver. Therefore, there is a possibility that the depression of the brake pedal is erroneously determined.

The present disclosure has been made to solve the above problem, and an object thereof is to provide a vehicle capable of preventing an erroneous determination of a depression of a brake pedal.

The vehicle according to the present disclosure is configured enable autonomous driving through an autonomous driving kit that is attachable and detachable and that issues an instruction for autonomous driving. The vehicle includes
a vehicle platform,
a brake pedal configured to receive a braking operation of a driver of the vehicle platform,
a driving assistance system configured to assist the driver in braking the vehicle,
a braking function unit configured to brake the vehicle platform in accordance with the braking operation received by the brake pedal, and a braking instruction from the autonomous driving kit or the driving assistance system, and
a vehicle control interface box configured to relay control communication between the autonomous driving kit and the braking function unit.

The vehicle control interface box is configured to:
output, to the autonomous driving kit, a brake pedal intervention signal of a value corresponding to the braking operation received by the brake pedal; and
prohibit outputting a brake pedal intervention signal of a specific value indicating that the braking operation is performed to the autonomous driving kit, in a determination period after a requested deceleration by the braking instruction exceeds a first threshold value and until a first period has elapsed.

With such a configuration, it is possible to suppress outputting, to the autonomous driving kit, the signal indicating that the braking operation of the brake pedal is performed even though the driver does not operate the brake pedal, in the determination period until the first period has elapsed during a sudden deceleration. As a result, it is possible to provide a vehicle capable of preventing an erroneous determination of a depression of a brake pedal.

The vehicle control interface box may be configured to:
determine that the braking operation is in an operation-present state in which the braking operation is performed, in a case where a fluctuation value corresponding to an operation amount of the braking operation is equal to or greater than a second threshold value; and
output, to the autonomous driving kit, the brake pedal intervention signal of the specific value, in a case where the operation-present state continues for a second period or longer in the determination period.

With such a configuration, in a case where a state in which the fluctuation value corresponding to the operation amount of the braking operation is equal to or greater than the second threshold value continues for the second period or longer in the determination period until the first period has elapsed during a sudden deceleration, the following is performed. That is, the brake pedal intervention signal of the specific value indicating that the braking operation is performed is output to the autonomous driving kit. As a result, even in a case where the sudden deceleration is performed in accordance with the braking instruction from the autonomous driving kit or the driving assistance system, the intervention of the braking operation performed by the driver can be appropriately determined.

The vehicle control interface box may be configured to output, to the autonomous driving kit, a brake pedal intervention signal of a value different from the specific value and indicating that the braking operation is not performed, in a case where the operation-present state is not continued for the second period or longer in the determination period.

With such a configuration, in a case where a state in which the fluctuation value corresponding to the operation amount of the braking operation is equal to or greater than the second threshold value is not continued for the second period or longer in the determination period until the first period has elapsed during a sudden deceleration, the following is performed. That is, the brake pedal intervention signal of the value indicating that the braking operation is not performed is output to the autonomous driving kit. As a result, in a case where the sudden deceleration is performed in accordance with the braking instruction from the autonomous driving kit or the driving assistance system, it is possible to appropriately determine that there is no intervention of the braking operation performed by the driver.

The vehicle control interface box may be configured to output, to the autonomous driving kit, the brake pedal intervention signal of the specific value, in a case where a determination is made that the braking operation is in the operation-present state not in the determination period.

With such a configuration, in a state in which the fluctuation value corresponding to the operation amount of the braking operation is equal to or greater than the second threshold value not in the determination period that is until the first period has elapsed during a sudden deceleration, the following is performed. That is, the brake pedal intervention signal of the specific value indicating that the braking operation is performed is output to the autonomous driving kit. As a result, even in a case where the sudden deceleration is performed in accordance with the braking instruction from the autonomous driving kit or the driving assistance system, the intervention of the braking operation performed by the driver can be appropriately determined.

The fluctuation value is a value that fluctuates in accordance with the operation amount of the brake pedal, and fluctuates in a case where the braking operation is performed and also by braking based on the braking instruction.

According to the present disclosure, it is possible to provide the vehicle capable of preventing the erroneous determination of the depression of the brake pedal.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an outline of a MaaS system in which a vehicle according to the embodiment of the present disclosure is used;

FIG. 2 is a diagram showing a configuration of the vehicle in more detail;

FIG. 3 is a diagram showing an outline of a configuration of a hydraulic pressure circuit of a brake system;

FIG. 4 is a first flowchart showing a flow of a brake pedal intervention process executed by the VCIB in the present embodiment;

FIG. 5 is a second flowchart showing a flow of a brake pedal intervention process executed by the VCIB in the present embodiment;

FIG. 6A is a diagram showing a timing chart of a determination of an operation of a brake pedal in the embodiment; and

FIG. 6B is a diagram showing a timing chart regarding determination of the operation of the brake pedal in the present embodiment.

### DETAILED DESCRIPTION OF EMBODIMENTS

Hereinafter, the embodiment of the present disclosure will be described in detail with reference to the drawings. Note that, in the drawings, the same or equivalent parts are denoted by the same reference numerals, and description thereof will not be repeated.

In the following embodiment, an example in which the ADK is mounted on a mobility as a service vehicle (MaaS vehicle) will be described. The autonomous driving kit is a tool that integrates a set of hardware and software for realizing autonomous driving, and is one embodiment of an autonomous driving system (ADS). The type of the vehicle on which the autonomous driving kit can be mounted is not limited to the MasS vehicle. The autonomous driving kit can be applied to general vehicles that can implement autonomous driving.

### Entire Configuration

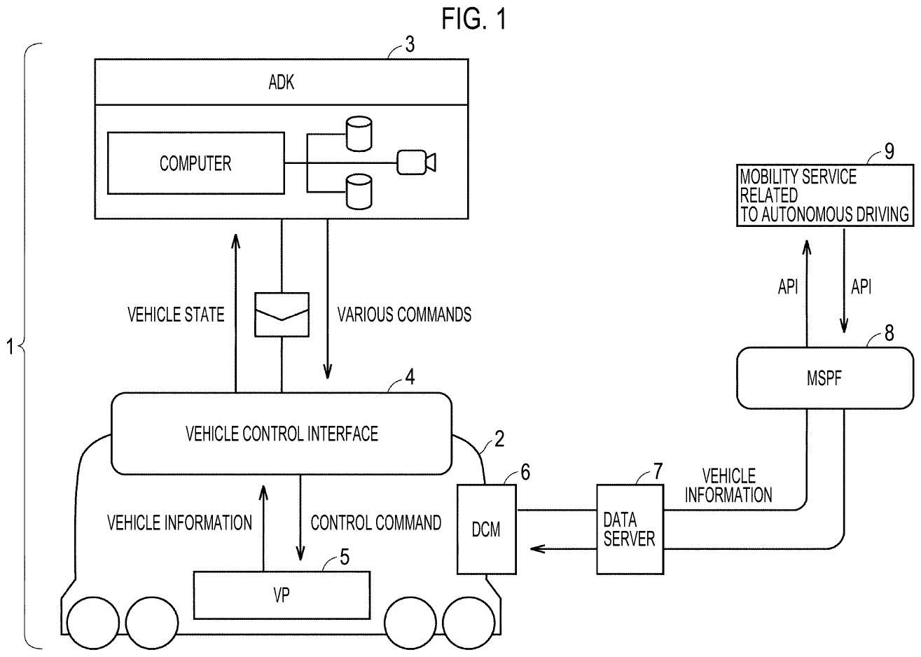

FIG. 1 is a diagram showing an outline of a MasS system in which a vehicle 1 according to the embodiment of the present disclosure is used. With reference to FIG. 1, the MasS system includes a vehicle 1. The vehicle 1 includes a vehicle body 2 and an autonomous driving kit (ADK) 3. The vehicle body 2 includes a vehicle control interface 4, a vehicle platform (VP) 5, and a data communication module (DCM) 6. The MaaS system includes a data server 7, a mobility service platform (MSPF) 600, and a mobility service 9 related to autonomous driving in addition to the vehicle 1.

The vehicle 1 can perform autonomous driving in response to a command from an ADK 3 attached to a vehicle body 2. In FIG. 1, the vehicle body 2 and the ADK 3 are shown at separated positions, but actually, the ADK 3 is attached to a roof top or the like of the vehicle body 2.

The ADK 3 can also be removed from the vehicle body 2. In a case where the ADK 3 is removed, the vehicle body 2 can travel by the driving of the driver. In this case, the VP 5 executes traveling control in the manual mode (traveling control according to the driver operation).

The vehicle control interface 4 can communicate with the ADK 3 via a controller area network (CAN) or the like. The vehicle control interface 4 executes a predetermined application program interface (API) defined for each signal to be communicated. As a result, the vehicle control interface 4 receives various commands from the ADK 3 and outputs the state of the vehicle body 2 to the ADK 3.

When the vehicle control interface 4 receives the command from the ADK 3, the vehicle control interface 4 outputs the control command corresponding to the command to the VP 5. The vehicle control interface 4 acquires various pieces of information of the vehicle body 2 from the VP 5 and outputs the state of the vehicle body 2 to the ADK 3. The configuration of the vehicle control interface 4 will be described in detail later.

The VP 5 includes various systems and various sensors for controlling the vehicle body 2. The VP 5 executes the vehicle control in response to the command instructed from the ADK 3 through the vehicle control interface 4. That is, the autonomous driving of the vehicle 1 is executed by the execution of the vehicle control by the VP 5 in response to the command from the ADK 3. The configuration of the VP 5 will also be described in detail later.

The ADK 3 is a kind of autonomous driving system (ADS) for performing autonomous driving of the vehicle 1. The ADK 3 creates, for example, a travel plan of the vehicle 1 and outputs various commands for traveling the vehicle 1 in accordance with the created travel plan to the vehicle control interface 4 in accordance with an API defined for each command. The ADK 3 receives various signals indicating the state of the vehicle body 2 from the vehicle control interface 4 in accordance with the API defined for each signal, and reflects the received vehicle state in creating the traveling plan. The configuration of the ADK 3 (ADS) will be described later.

The DCM 6 includes a communication interface for the vehicle body 2 to perform wireless communication with the data server 7. The DCM 6 outputs various pieces of vehicle information, such as speed, position, and autonomous driving state, to the data server 7. The DCM 6 receives various data for managing traveling of the autonomous driving vehicle including the vehicle 1 in the mobility service 9 related to autonomous driving, for example, from the mobility service 9 via the MSPF 8 and the data server 7.

The data server 7 is configured to perform wireless communication with various autonomous driving vehicles including the vehicle 1, and is also configured to communicate with the MSPF 8. The data server 7 stores various data (vehicle state data and vehicle control data) for managing the traveling of the autonomous driving vehicle.

The MSPF 8 is a unified platform to which various mobility services are connected. Various mobility services other than the autonomous driving-related mobility service 9 can be connected to the MSPF 8. The autonomous driving-related mobility service is, for example, various mobility services provided by a ride-sharing company, a car-sharing company, an insurance company, a car rental company, a taxi company, or the like. Various mobility services including the mobility service 9 can use various functions provided by the MSPF 8 according to the service content by using the API published on the MSPF 8.

The mobility service 9 related to autonomous driving provides the mobility service using the autonomous driving vehicle including the vehicle 1. The mobility service 9 can acquire, for example, driving control data of the vehicle 1 that communicates with the data server 7 and/or information stored in the data server 7 from the MSPF 8 by using the API published on the MSPF 8. The mobility service 9 transmits, for example, data for managing the autonomous driving vehicle including the vehicle 1 to the MSPF 8 by using the above API.

The MSPF 8 publishes an API for using various data of the vehicle state and the vehicle control needed for the development of the ADS. The operator of the ADS can use the data on the vehicle state and the vehicle control stored in the data server 7 as the API needed for the development of the ADS.

### Vehicle Configuration

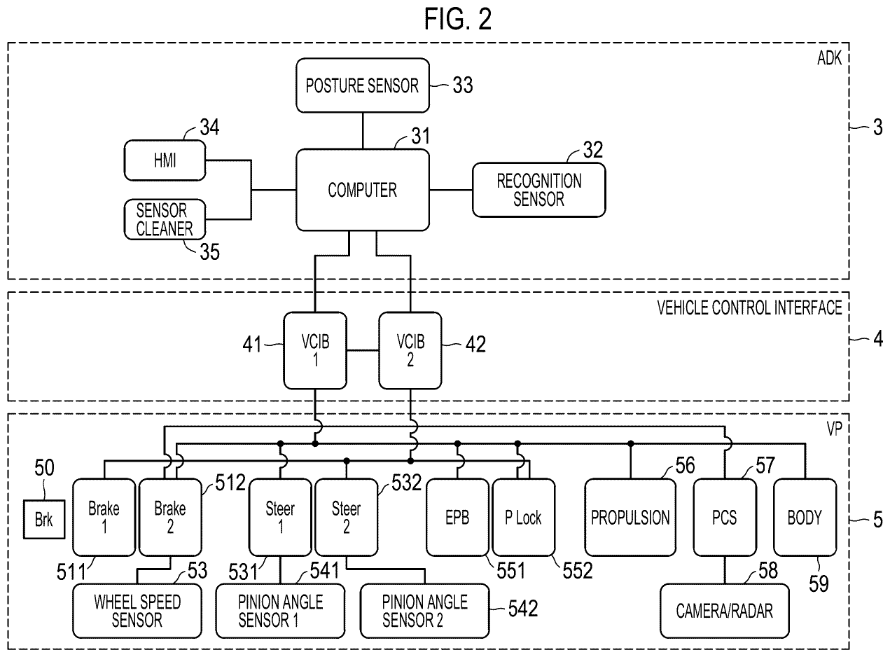

FIG. 2 is a diagram showing the configuration of the vehicle 1 in more detail. With reference to FIG. 2, the ADK 3 includes a computer 31, a recognition sensor 32, a posture sensor 33, a human machine interface (HMI) 34, and a sensor cleaner 35.

The computer 31 acquires the environment around the vehicle, the posture, behavior, and position of the vehicle 1 by using various sensors (described below) during autonomous driving of the vehicle 1. The computer 31 acquires the state of the vehicle 1 from the VP 5 via the vehicle control interface 4, and sets the next operation of the vehicle 1 (acceleration, deceleration, turning, and the like). The computer 31 outputs a command for realizing the set next operation to the vehicle control interface 4.

The recognition sensor 32 recognizes the environment around the vehicle. Specifically, the recognition sensor 32 includes at least one of a laser detection and ranging (LIDAR), a millimeter wave radar, and a camera.

The LIDAR measures a distance to a target object (a person, another vehicle, an obstacle, or the like) by irradiating the target object with infrared pulse laser light and measuring a time until the irradiation light is reflected and returns. The millimeter wave radar irradiates the target object with millimeter waves, detects millimeter waves reflected by the target object, and measures a distance to the target object and/or a direction of the target object. The camera is disposed, for example, on the back side of a room mirror in a vehicle cabin and captures an image in front of the vehicle 1. The image processing can be performed on the image captured by the camera by using an image processing processor equipped with artificial intelligence (AI). The information acquired by the recognition sensor 32 is output to the computer 31.

The posture sensor 33 detects the posture, behavior, and position of the vehicle 1. Specifically, the posture sensor 33 may include, for example, an inertial measurement unit (IMU) and a global positioning system (GPS).

The IMU detects, for example, the acceleration in the front-rear direction, the right-left direction, and the up-down direction of the vehicle 1, and the angular velocity in the roll direction, the pitch direction, and the yaw direction of the vehicle 1. The GPS detects the position of the vehicle 1 by using information received from a plurality of GPS satellites orbiting the earth. The information acquired by the posture sensor 33 is also output to the computer 31.

The HMI 34 includes, for example, a display device, a voice output device, and an operation device. Specifically, the HMI 34 may include a touch panel display and/or a smart speaker (AI speaker). The HMI 34 provides the user with information or receives the user's operation when the vehicle 1 is autonomously driven, when the vehicle 1 is driven in a manual mode, or when the mode is changed.

The sensor cleaner 35 is configured to remove dirt adhering to each sensor. More specifically, the sensor cleaner 35 removes dirt such as a camera lens, a laser irradiation unit, or a millimeter wave irradiation unit using a cleaning liquid or a wiper.

The vehicle control interface 4 includes VCIBs 41, 42. The VCIBs 41, 42 include a processor, such as a central processing unit (CPU), and a memory, such as a read only memory (ROM) and a random access memory (RAM). Each of the VCIBs 41, 42 is communicably connected to the computer 31 of the ADK 3. The VCIBs 41, 42 are connected to be able to communicate with each other.

Each of the VCIBs 41, 42 relays various commands from the ADK 3 and outputs the commands to the VP 5 as a control command. More specifically, each of the VCIBs 41, 42 uses a program or the like stored in the memory to convert various commands output from the ADK 3 into control commands used to control each system of the VP 5. Each of the VCIBs 41, 42 outputs the control command to the system on the connection destination. In addition, each of the VCIBs 41, 42 appropriately processes the vehicle information output from the VP 5 (including relaying) and outputs the vehicle information to the ADK 3 as the vehicle state.

Although the connection destination of the VCIBs 41, 42 is partially different for the systems configuring the VP 5, the VCIBs 41, 42 basically have the same function. The control system between the ADK 3 and the VP 5 is redundant (duplicated) by the fact that the VCIBs 41, 42 have the same function with respect to the operation of the brake system, the steering system, and the like. Therefore, even in a case where some kind of failure occurs in a part of the system, the function (steering, braking, and the like) of the VP 5 can be maintained by switching the control system or interrupting the control system in which the failure has occurred.

The VP 5 includes a brake pedal 50, brake systems 511, 512, wheel speed sensors 53, steering systems 531, 532, and pinion angle sensors 541, 542. The VP 5 includes an electric parking brake (EPB) system 551, a P lock system 552, a propulsion system 56, a pre-collision system (PCS) 57, a camera/radar 58, and a body system 59.

The VCIB 41 is connected to the brake system 512, the steering system 531, and the P lock system 552 among the systems of the VP 5 so as to communicate with each other via a communication bus. The VCIB 42 is connected to the brake systems 511, 512, the steering system 532, and the EPB system 551 among the systems of the VP 5 so as to communicate with each other via a communication bus. The VCIB 42 is connected to the P lock system 552, the propulsion system 56, and the body system 59 so as to communicate with each other via a communication bus.

The brake pedal 50 receives a driver operation (depression operation). A brake position sensor that detects a depression amount of the brake pedal 50 is provided in the brake pedal 50.

The brake systems 511, 512 are configured to control a plurality of braking devices provided in each of the wheels of the vehicle 1. The braking device may include a disc brake system that operates using hydraulic pressure adjusted by an actuator. The brake systems 511, 512 may be configured to have the same function. Alternatively, one of the brake systems 511, 512 may be configured to independently control the braking force of each wheel during vehicle traveling, and the other may be configured to control the same braking force in each wheel during vehicle traveling.

Each of the brake systems 511, 512 generates a braking command to the braking device in accordance with a predetermined control command transmitted from the ADK 3 through the vehicle control interface 4. The brake systems 511, 512 control the braking devices using, for example, the braking command generated by any one of the brake systems. Further, the brake systems 511, 512 control the braking devices by using the braking command generated by the other brake system in a case where the abnormality occurs in any one of the brake systems.

The wheel speed sensor 53 is connected to the brake system 512 in this example. The wheel speed sensor 53 is provided in each of the wheels of the vehicle 1, for example. The wheel speed sensor 53 detects the rotation speed of each wheel and outputs the detected rotation speed to the brake system 512. The brake system 512 outputs the rotation speed of each wheel to the VCIB 41 as one of the pieces of information included in the vehicle information.

The steering systems 531, 532 are configured to control a steering angle of a steering wheel of the vehicle 1 using a steering device. The steering device includes, for example, a rack and pinion type electric power steering (EPS) in which a steering angle can be adjusted by an actuator.

The steering systems 531, 532 have the same function. Each of the steering systems 531, 532 generates a steering command to the steering device in accordance with a predetermined control command output from the ADK 3 through the vehicle control interface 4. The steering systems 531, 532 control the steering device using, for example, the steering command generated by any one of the steering systems. In a case where the abnormality occurs in any one of the steering systems 531, 532, the steering device is controlled by using the braking command generated by the other steering system.

The pinion angle sensor 541 is connected to the steering system 531. The pinion angle sensor 542 is connected to the steering system 532. Each of the pinion angle sensors 541, 542 detects a rotation angle (pinion angle) of a pinion gear connected to a rotation shaft of the actuator, and outputs the detected pinion angle to the steering systems 531, 532, respectively.

The EPB system 551 is configured to control the EPB provided in the wheels of the vehicle 1. The EPB is provided separately from the braking devices of the brake systems 511, 512, and fixes the wheels by the operation of the actuator. The actuator may be an actuator that can adjust the oil pressure supplied to the braking device separately from the brake systems 511, 512. The EPB, for example, operates a drum brake for a parking brake using an actuator to fix wheels.

The P lock system 552 is configured to control a P lock device provided in the transmission of the vehicle 1. More specifically, a gear (lock gear) is provided to be connected to a rotating element in the transmission. Further, a parking lock pole whose position can be adjusted by an actuator is provided for the teeth of the lock gear. The P lock device fixes the rotation of the output shaft of the transmission by fitting a protrusion portion positioned at the tip end of the parking lock pole.

The propulsion system 56 is configured to switch the shift range using the shift device and to control the driving force of the vehicle 1 in the traveling direction using the drive source. The shift device is configured to select any one of a plurality of shift ranges. The drive source may include a motor generator, an engine, and the like.

The PCS 57 executes control for avoiding the collision of the vehicle 1 or reducing the damage by using the camera/radar 58. More specifically, the PCS 57 is connected to the brake system 512. The PCS 57 detects the object in front by using the camera/radar 58 and determines whether there is a possibility of collision with the vehicle 1 based on a distance to the object. When the PCS 57 determines that there is a possibility of a collision, the PCS 57 outputs a braking command to the brake system 512 such that the braking force is increased.

The body system 59 is configured to control various components (a direction indicator, a horn, a wiper, or the like) according to, for example, a traveling state or a traveling environment of the vehicle 1.

Systems other than the brake systems 511, 512 and the steering systems 531, 532 are also configured to control the corresponding devices in accordance with predetermined control commands transmitted from the ADK 3 through the vehicle control interface 4. Specifically, the EPB system 551 receives the control command from the ADK 3 via the vehicle control interface 4, and controls the EPB in accordance with the control command. The P lock system 552 receives the control command from the ADK 3 via the vehicle control interface 4, and controls the P lock device in accordance with the control command. The propulsion system 56 receives the control command from the ADK 3 via the vehicle control interface 4, and controls the shift device and the drive source in accordance with the control command. The body system 59 receives the control command from the ADK 3 via the vehicle control interface 4, and controls the component parts in response to the control command.

An operation device that can be manually operated by the user may be separately provided for the above-described braking device, the steering device, the EPB, the P lock, the shift device, the drive source, and the like.

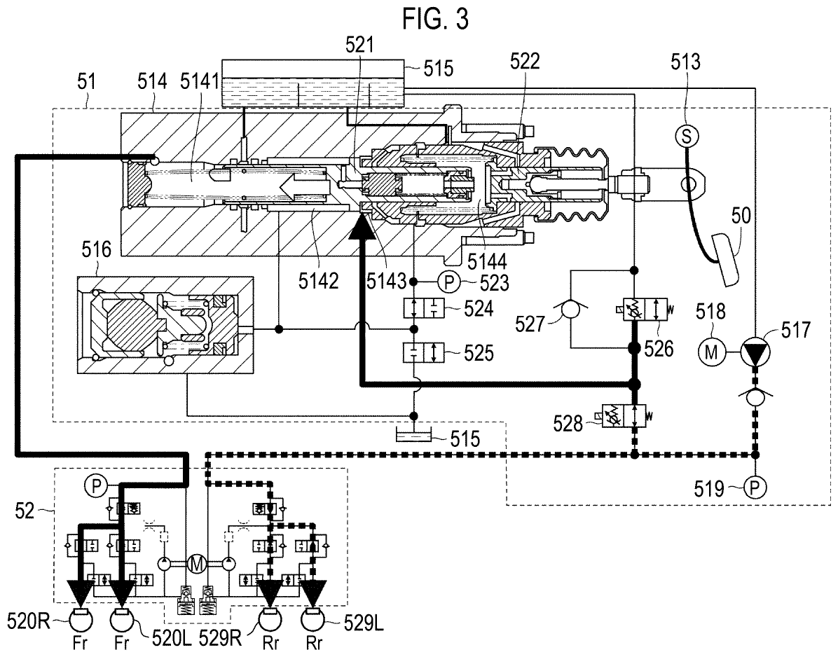

FIG. 3 is a diagram showing an outline of the configuration of the hydraulic pressure circuits of the brake systems 511, 512. With reference to FIG. 3, the hydraulic circuit includes a reservoir tank 515 that stores brake fluid, an upstream unit 51, a downstream unit 52, wheel cylinders 520R, 520L for front wheels, and wheel cylinders 529R, 529L for rear wheels. The upstream unit 51 includes a master cylinder 514, an input piston 522, an output piston 521, a stroke simulator 516, and a power supply unit. The upstream unit 51 includes a stroke sensor 513, hydraulic pressure sensors 519, 523, a piston gap holding valve 524, and a simulator opening valve 525. The power supply unit includes a gear pump 517, a brushless motor 518, normal open type linear valves 526, 528, and a check valve 527. The downstream unit 52 includes an electronic stability control (ESC) unit.

The input piston 522 and the output piston 521 are inserted into the master cylinder 514. The input piston 522 is linked to the brake pedal 50. The master cylinder 514 is provided with a disengagement chamber 5144, a servo chamber 5143, a reaction force chamber 5142, and a master chamber 5141. The piston gap holding valve 524 is provided in a fluid passage in which the disengagement chamber 5144 and the reaction force chamber 5142 are connected. The fluid passage is connected to the reservoir tank 515 through the simulator opening valve 525. When the brake systems 511, 512 are operated, the piston gap holding valve 524 is opened, and the simulator opening valve 525 is closed.

When the brake pedal 50 is operated, the brake fluid in the disengagement chamber 5144 is compressed, so that the operation force of the brake pedal 50 is generated by the stroke simulator 516 connected to the reaction force chamber 5142.

The power supply unit operates in a case where a braking request is made. In the power supply unit, two linear valves 526, 528 are disposed in series in the circulation flow of the brake fluid generated by the gear pump 517. The front and rear wheel independent control is realized by individually controlling the two linear valves 526, 528. The circulation flow is connected to the servo chamber 5143 between the two linear valves 526, 528. The master chamber 5141 facing the servo chamber 5143 is connected to the wheel cylinders 520R, 520L for the front wheels. The circulation flow is connected between the discharge portion of the gear pump 517 and the linear valve 528, and the wheel cylinders 529R, 529L for the rear wheels.

When a braking request is made, the brushless motor 518 and the linear valves 526, 528 are controlled by the electronic control units (ECUs) of the brake systems 511, 512. In the brake systems 511, 512, the ECU decides target values of hydraulic pressures of brake fluids of the front wheels and the rear wheels based on the operation amount of the brake pedal detected by the stroke sensor 513. The ECU drives the brushless motor 518 and the linear valves 526, 528 such that the hydraulic pressures of the front wheels and the rear wheels detected by the hydraulic pressure sensors 523, 519 match the target values.

### Problem and Solution

In the above-described configuration, the presence or absence of depression of the brake pedal 50 is determined from the depression amount of the brake pedal 50. However, when the vehicle is automatically driven by the ADK 3 and is rapidly decelerated, the back pressure of the master cylinder 514 and the like is changed in association with a sudden change in the hydraulic pressure of the hydraulic circuit of the brake systems 511, 512. As a result, the input piston 522 and the output piston 521 may move. Therefore, there is a possibility that the brake pedal 50 is erroneously determined to be depressed by the driver even though the driver does not operate the brake pedal 50.

Therefore, the VCIBs 41, 42 output a brake pedal operation signal of a value according to the braking operation received by the brake pedal 50 to the ADK 3. Then, the VCIBs 41, 42 perform the following when the determination period is a period until the first period elapses after the requested deceleration by the braking instruction becomes greater than the first threshold value. That is, the VCIBs 41, 42 prohibit the output of the brake pedal operation signal of the specific value indicating that the braking operation is performed to the ADK 3.

As a result, in a case where the first period is the determination period until the first period elapses during the sudden deceleration, it is possible to suppress the output of the ADK 3 indicating that the braking operation of the brake pedal 50 is performed even though the driver does not operate the brake pedal 50. As a result, it is possible to prevent the erroneous determination of the depression of the brake pedal 50.

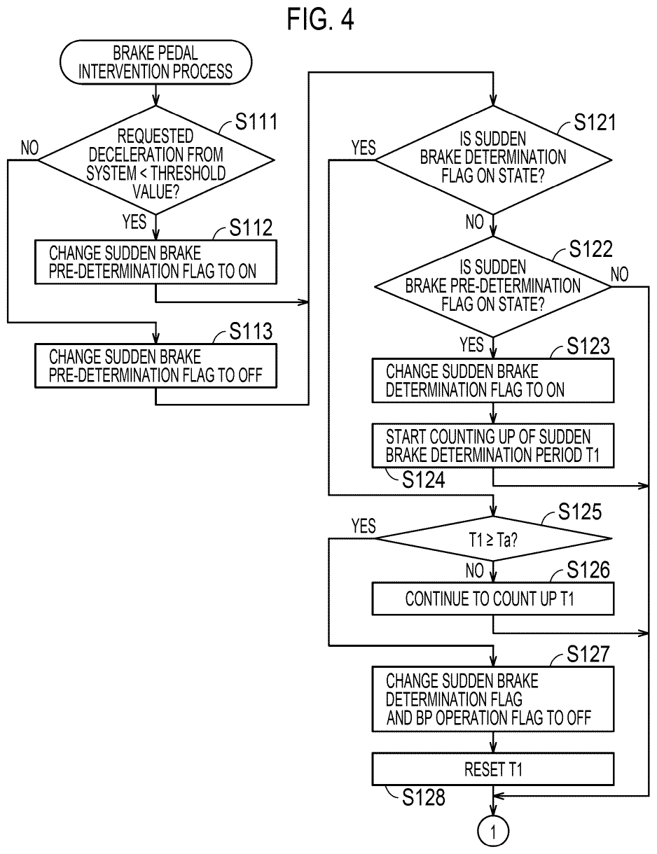

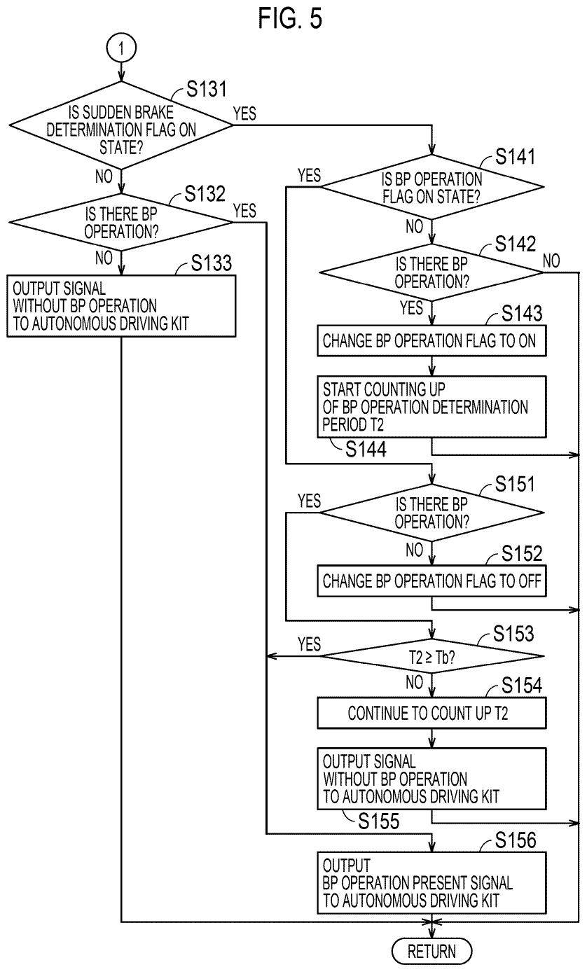

FIGS. 4 and 5 are first and second flowcharts showing a flow of a brake pedal intervention process executed by the VCIB in the present embodiment, respectively. With reference to FIGS. 4 and 5, the brake pedal intervention process is called and executed from the higher-level process at a predetermined cycle by the processors of the VCIBs 41, 42. Each step included in the flowchart is basically realized by software processing by the vehicle 1 (VP 5 or vehicle control interface 4). However, each step included in the flowchart may be realized by dedicated hardware (electric circuit) prepared in the VP 5 or the vehicle control interface 4.

The processors of the VCIBs 41, 42 determine whether a requested deceleration indicated by a braking request from a system, such as the ADK 3 or a driving assistance system (for example, PCS 57), is less than a predetermined first threshold value (S111). When determination is made that the requested deceleration is less than a predetermined first threshold value (YES in S111), the processors of the VCIBs 41, 42 change the sudden brake pre-determination flag to an on state (S112). The sudden brake pre-determination flag is a flag indicating whether the requested deceleration from the system is less than a predetermined first threshold value. On the other hand, when the processor determines that the requested deceleration is not less than the predetermined first threshold value (NO in S111), the processors of the VCIBs 41, 42 change the sudden brake pre-determination flag to the off state (S113).

After S112 or S113, the processors of the VCIBs 41, 42 determine whether the sudden brake determination flag is in an on state (S121). The sudden brake determination flag is a flag indicating whether the period is a period for determining whether there is an operation of the brake pedal 50 after the requested deceleration indicated by the braking request from the system is less than a predetermined first threshold value. When determination is made that the sudden brake determination flag is in the off state (NO in S121), the processors of the VCIBs 41, 42 determine whether the sudden brake pre-determination flag is in the on state (S122).

When determination is made that the sudden brake pre-determination flag is in the on state (YES in S122), the processors of the VCIBs 41, 42 change the sudden brake determination flag to the on state (S123). Next, the processors of the VCIBs 41, 42 start counting up of the sudden braking determination period T1 (S124). The sudden brake determination period is a period in which determination is made whether the operation of the brake pedal 50 is detected after the requested deceleration indicated by the braking request from the system is less than a predetermined first threshold value.

On the other hand, when determination is made that the sudden brake determination flag is in the on state (YES in S121), the processors of the VCIBs 41, 42 determine whether the sudden braking determination period T1 is equal to or longer than the predetermined period Ta (S125). When determination is made that the sudden braking determination period T1 is not equal to or greater than the predetermined period Ta (NO in S125), the processors of the VCIBs 41, 42 continue to count up the sudden braking determination period T1 (S126). On the other hand, in a case where the determination is made that the sudden braking determination period T1 is equal to or longer than the predetermined period Ta (YES in S125), the processors of the VCIBs 41, 42 change the sudden brake determination flag and the BP operation flag to an off state (S127). The BP operation flag is a flag indicating that the operation of the brake pedal 50 is detected in the sudden braking determination period. Next, the processors of the VCIBs 41, 42 reset the sudden braking determination period T1 to zero (S128).

When determination is made that the sudden brake pre-determination flag is not in the on state (NO in S122), after S124, after S126, or after S128, the processors of the VCIBs 41, 42 make the following determination. The processors of the VCIBs 41, 42 determine whether the sudden braking determination flag is in the on state (S131). When determination is made that the sudden brake determination flag is not in the on state (NO in S131), the processors of the VCIBs 41, 42 make the following determination. The processors of the VCIBs 41, 42 determine whether the brake pedal 50 is operated by using a brake operation amount signal indicating an operation amount of the brake pedal 50, the brake operation amount signal being input from a stroke sensor 513 of the brake pedal 50 (S132).

When determination is made that the brake pedal 50 is not operated (NO in S132), the processors of the VCIBs 41, 42 output a signal without the BP operation indicating that the brake pedal 50 is not operated to the ADK 3 (S133). On the other hand, in a case where the determination is made that the operation of the brake pedal 50 is performed (YES in S132), the processors of the VCIBs 41, 42 output a BP operation-present signal indicating that the operation of the brake pedal 50 is performed to the ADK 3 (S156).

On the other hand, in a case where determination is made that the sudden braking determination flag is in the on state (YES in S131), the processors of the VCIBs 41, 42 determine whether the BP operation flag is in the on state (S141). When determination is made that the BP operation flag is not in the on state (NO in S141), the processors of the VCIBs 41, 42 make the following determination. The processors of the VCIBs 41, 42 determine whether the brake pedal 50 is operated by using a brake operation amount signal indicating an operation amount of the brake pedal 50, the brake operation amount signal being input from a stroke sensor 513 of the brake pedal 50 (S142).

When determination is made that the brake pedal 50 is operated (YES in S142), the processors of the VCIBs 41, 42 change the BP operation flag to an on state (S143). Next, the processors of the VCIBs 41, 42 start counting up of the BP operation determination period T2 (S144). The BP operation determination period is a period in which the operation of the brake pedal 50 is detected until the sudden braking determination period T1 reaches the predetermined period Ta.

On the other hand, when determination is made that the BP operation flag is in the on state (YES in S141), the processors of the VCIBs 41, 42 make the following determination. The processors of the VCIBs 41, 42 determine whether the brake pedal 50 is operated by using a brake operation amount signal indicating an operation amount of the brake pedal 50, the brake operation amount signal being input from a stroke sensor 513 of the brake pedal 50 (S151). When determination is made that the brake pedal 50 is not operated (NO in S151), the processors of the VCIBs 41, 42 change the BP operation flag to an off state (S152).

On the other hand, in a case where the processor determines that the operation of the brake pedal 50 is present (YES in S151), the processors of the VCIBs 41, 42 determine whether the BP operation determination period T2 is equal to or longer than a predetermined period Tb (S153). When determination is made that the BP operation determination period T2 is not equal to or greater than the predetermined period Tb (NO in S153), the processors of the VCIBs 41, 42 continue to count up the BP operation determination period T2 (S154). Next, the processors of the VCIBs 41, 42 output the signal without the BP operation to the ADK 3, as in S133 (S155).

On the other hand, in a case where the determination is made that the BP operation determination period T2 is equal to or longer than the predetermined period Tb (YES in S153), the processors of the VCIBs 41, 42 output the BP operation-present signal to the ADK 3 (S156) as described in S156.

In a case where determination is made that there is no operation of the brake pedal (NO in S142), the processors of the VCIBs 41, 42 make the following determination after S144, after S152, after S155, or after S156. The processors of the VCIBs 41, 42 return the processing to be executed to the upper process of the brake pedal intervention processing, which is the calling source of the brake pedal intervention processing. The predetermined periods Ta, Tb are, for example, periods shorter than one second.

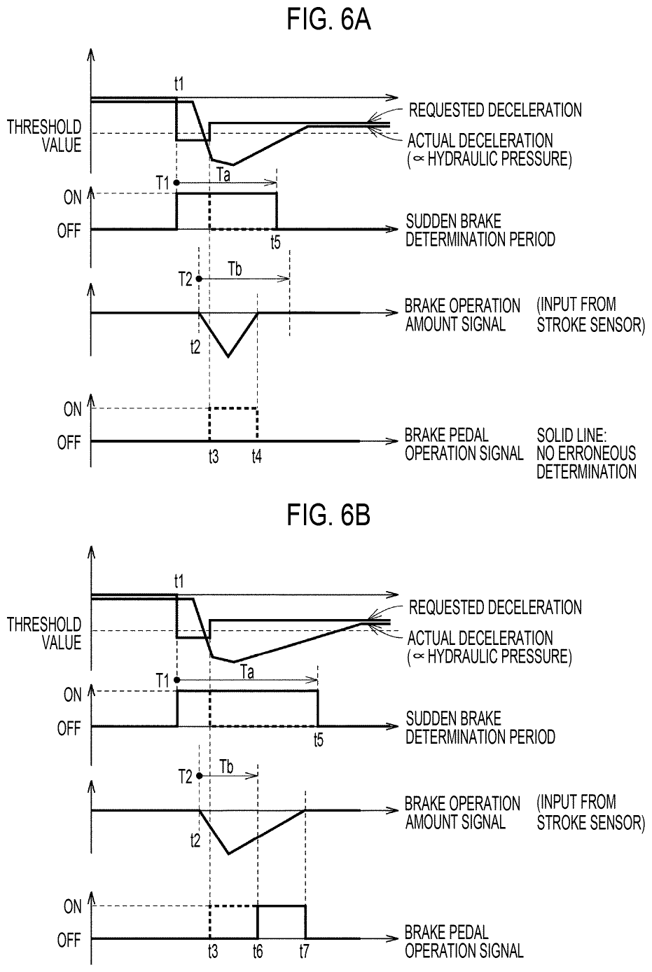

FIGS. 6A and 6B are diagrams showing a timing chart regarding determination of the operation of the brake pedal in the present embodiment. Referring to FIG. 6A, in this example, the requested deceleration from the system is zero at time t1, and is larger than the first threshold value, and is smaller than the first threshold value at time t3. The actual deceleration may follow the requested deceleration with a slight delay and overshoot slightly. The actual deceleration is proportional to the hydraulic pressure applied to the wheel cylinders 520R, 520L, 529R, 529L of the hydraulic pressure circuits of the brake systems 511, 512 in an outline.

Here, it is assumed that the sudden braking determination period T1 is a period in which the requested deceleration exceeds the first threshold value, that is, a period from time t1 to time t3. In this case, the back pressure of the master cylinder 514 of the brake systems 511, 512 is increased due to the influence of the increase in the actual deceleration. As a result, the brake operation amount signal indicating the operation amount of the brake pedal 50 input from the stroke sensor 513 is increased or decreased according to the actual deceleration at around time t2 between time t1 and time t3, and becomes zero at time t4. Therefore, the brake pedal operation-present signal indicating that the brake pedal 50 is operated is output to the ADK 3 from time t3 to time t4.

As shown in FIGS. 4 and 5 of the embodiment, when the predetermined period Ta of the sudden braking determination period T1 is provided, the following is performed until the time t5 when the sudden braking determination period T1 reaches the predetermined period Ta. That is, even when the brake operation amount signal is input, the process of FIG. 4 and the process of FIG. 5 are executed, so that the determination is made that the brake operation amount signal is input under the influence of the deceleration request from the system. Then, the brake pedal operation-present signal can be restrained from being output to the ADK 3 from time t3 to time t4.

FIG. 6A shows a case where the BP operation deciding period T2 in which the brake operation amount signal is input is less than the predetermined period Tb. FIG. 6B shows a case where the BP operation determination period T2 in which the brake operation amount signal is input is equal to or longer than Tb. With reference to FIG. 6B, the BP operation determination period T2 reaches the predetermined period Tb at time t6. The brake operation amount signal increases or decreases according to the actual deceleration from time t2, and becomes 0 at time t7 after time T6. By executing the processing of FIGS. 4 and 5, the following determination is made after a time t6 when the BP operation determination period T2 reaches the predetermined period Tb. That is, the determination is made that the brake operation amount signal is not input under the influence of the deceleration request from the system, but is input according to the operation of the driver. Therefore, from time t6 to time t7 when the brake operation amount signal becomes 0, the brake pedal operation-present signal is output to the ADK 3.

### Modification Example

(1) In the above-described embodiment, the driving assistance system that assists the driver in braking the vehicle is the PCS 57. However, the present disclosure is not limited thereto, and the driving assistance system may be another system, for example, a parking support brake (PKSB).

(2) In the above-described embodiment, as shown in S132, S142, and S151 of FIG. 5, and FIGS. 6A and 6B, when the brake operation amount signal from the stroke sensor 513 is zero or more, the determination is made that the brake pedal 50 is operated. However, the present disclosure is not limited thereto, and a condition for determining that the brake pedal 50 is operated may be a condition that a variation value of the operation amount of the braking operation is equal to or greater than a second threshold value. For example, the variation value with respect to the operation amount of the braking operation may be another value instead of the value of the brake operation amount signal from the stroke sensor 513. For example, the fluctuation value with respect to the operation amount of the braking operation may be a value of the deceleration determined by the operation amount of the brake, or may be a pressure of the brake fluid in the hydraulic pressure circuit of the brake systems 511, 512. In addition, the second threshold value may be another value instead of “0”.

(3) The above-described embodiment can be regarded as a disclosure of the vehicle 1, the VP 5, or the VCIBs 41, 42, or can be regarded as a disclosure of a control method or a control program executed by the vehicle 1, the VP 5, or the VCIBs 41, 42.

### Summary

(1) As shown in FIGS. 1 and 2, the vehicle 1 is configured to be detachable with the ADK 3 that issues an instruction for autonomous driving and to be capable of autonomous driving. As shown in FIG. 1 to FIG. 3, the vehicle 1 includes a VP 5, a brake pedal 50 that receives a braking operation of a driver of the VP 5, and a driving assistance system (for example, a PCS 57) that assists the driver in braking of the vehicle 1. The vehicle 1 includes brake systems 511, 512 that brake the VP 5 in response to a braking operation received by the brake pedal 50 and a braking instruction from the ADK 3 or the driving assistance system. The vehicle 1 includes VCIBs 41, 42 that relay control communication between the ADK 3 and the brake systems 511, 512. As shown in FIGS. 4 to 6B, the VCIBs 41, 42 output a brake pedal intervention signal of a value according to the braking operation received by the brake pedal 50 to the ADK 3 (for example, S133, S155, S156). When the requested deceleration by the braking instruction is greater than the first threshold value, the VCIBs 41, 42 perform the following in a determination period (for example, T1) until the first period (for example, Ta) elapses. The VCIBs 41, 42 prohibit the output of the brake pedal intervention signal of the specific value indicating that the braking operation is performed (for example, the BP operation-present signal) to the ADK 3 (for example, output a signal without the brake pedal operation to the ADK 3 in S155).

As a result, in a case where the first period is the determination period until the first period elapses during the sudden deceleration, it is possible to suppress the output of the ADK 3 indicating that the braking operation of the brake pedal 50 is performed even though the driver does not operate the brake pedal 50. As a result, it is possible to prevent the erroneous determination of the depression of the brake pedal 50.

(2) As shown in FIGS. 4 to 6B, the VCIBs 41, 42 determine that the braking operation is in the operation-present state when the variation value (for example, the value of the brake operation amount signal from the stroke sensor 513) with respect to the operation amount of the braking operation is equal to or greater than a second threshold value (for example, 0) (for example, S132, S142, S151). When the determination period is the second period or more (for example, Tb), the VCIBs 41, 42 may output the brake pedal intervention signal of the specific value to the ADK 3 (for example, S156) when the operation-present state continues.

As a result, when the determination period is the first period that has elapsed during sudden deceleration, the following is performed when the state where the fluctuation value with respect to the operation amount of the braking operation is equal to or greater than the second threshold value continues for the second period or longer. A brake pedal intervention signal of a specific value indicating that the braking operation is performed is output to the ADK3. As a result, even in a case where the sudden deceleration is performed in accordance with the braking instruction from the ADK3 or the driving assistance system, the intervention of the driver in the braking operation can be appropriately determined.

(3) As shown in FIGS. 4 to 6B, the VCIBs 41, 42 may output a brake pedal intervention signal (for example, a signal without the BP operation) indicating that there is no braking operation different from the specific value to the ADK 3 (for example, S155) when the operation-present state is not continued for the second period or longer in the determination period.

As a result, when the first period is the determination period until the first period elapses during the sudden deceleration, the brake pedal intervention signal of the value indicating that the braking operation is not performed is output to the ADK3 when the state where the fluctuation value with respect to the operation amount of the braking operation is equal to or greater than the second threshold value is not continued for the second period or longer. As a result, in a case where the sudden deceleration is performed in accordance with the braking instruction from the ADK3 or the driving assistance system, it is possible to appropriately determine that the driver does not intervene in the braking operation.

(4) When the determination period is not set, the VCIBs 41, 42 may output the brake pedal intervention signal of the specific value to the ADK 3 when it is determined to be the operation-present state (for example, S156). The time that is not the determination period is, for example, when NO is determined in S131. The case where it is determined to be the operation-present state is, for example, a case where the determination is YES in S132.

As a result, in a case where the determination period is not a first period, when the fluctuation value with respect to the operation amount of the braking operation is equal to or greater than the second threshold value at the time of sudden deceleration, the brake pedal intervention signal of the specific value indicating that the braking operation is performed is output to the ADK3. As a result, even in a case where the sudden deceleration is performed in accordance with the braking instruction from the ADK3 or the driving assistance system, the intervention of the driver in the braking operation can be appropriately determined.

(5) The fluctuation value is a value that fluctuates according to the operation amount of the brake pedal 50, and fluctuates not only when the braking operation is performed, but also by the braking according to the braking instruction (for example, the braking instruction from the ADK3 or the driving assistance system). The braking operation is, for example, an operation of the brake pedal 50 by the driver.

The embodiment disclosed is to be considered merely illustrative and not restrictive in all respects. The scope of the present disclosure is indicated by the scope of claims rather than by the description of the above-described embodiment, and is intended to include all modifications within the scope and meaning equivalent to the scope of the claims.

What is claimed is:

1. A vehicle configured to enable autonomous driving through an autonomous driving kit that is attachable and detachable and that issues an instruction for autonomous driving, the vehicle comprising:
a vehicle platform;
a brake pedal configured to receive a braking operation of a driver of the vehicle platform;
a driving assistance system configured to assist the driver in braking the vehicle;
a braking function unit configured to brake the vehicle platform in accordance with the braking operation received by the brake pedal, and a braking instruction from the autonomous driving kit or the driving assistance system; and
a vehicle control interface box configured to relay control communication between the autonomous driving kit and the braking function unit, wherein:
the vehicle control interface box is configured to
output, to the autonomous driving kit, a brake pedal intervention signal of a value corresponding to the braking operation received by the brake pedal, and
prohibit outputting a brake pedal intervention signal of a specific value indicating that the braking operation is performed to the autonomous driving kit, in a determination period after a requested deceleration by the braking instruction exceeds a first threshold value and until a first period has elapsed.

2. The vehicle according to claim 1, wherein the vehicle control interface box is configured to:
determine that the braking operation is in an operation-present state in which the braking operation is performed, in a case where a fluctuation value corresponding to an operation amount of the braking operation is equal to or greater than a second threshold value; and
output, to the autonomous driving kit, the brake pedal intervention signal of the specific value, in a case where the operation-present state continues for a second period or longer in the determination period.

3. The vehicle according to claim 2, wherein the vehicle control interface box is configured to output, to the autonomous driving kit, a brake pedal intervention signal of a value different from the specific value and indicating that the braking operation is not performed, in a case where the operation-present state is not continued for the second period or longer in the determination period.

4. The vehicle according to claim 2, wherein the vehicle control interface box is configured to output, to the autonomous driving kit, the brake pedal intervention signal of the specific value, in a case where a determination is made that the braking operation is in the operation-present state not in the determination period.

5. The vehicle according to claim 2, wherein the fluctuation value is a value that fluctuates in accordance with the operation amount of the brake pedal, and fluctuates in a case where the braking operation is performed and also by braking based on the braking instruction.
